(19) United States
(12) Patent Application Publication
(10) Pub. No.: US 2018/0176526 A1
(43) Pub. Date: Jun. 21, 2018

(54) METHOD AND APPARATUS FOR CONTEXTUAL COLOR REMAPPING TRANSFORMATION IN CONTENT RENDERING

(71) Applicant: THOMSON Licensing, Issy-les-Moulineaux (FR)

(72) Inventors: Dayan SIVALINGAM, Mountain View, CA (US); Edwin HEREDIA, Los Altos, CA (US); Alexandru JUGRAVU, Los Altos, CA (US); Saurabh MATHUR, Los Altos, CA (US)

(21) Appl. No.: 15/846,564

(22) Filed: Dec. 19, 2017

Related U.S. Application Data
(60) Provisional application No. 62/435,894, filed on Dec. 19, 2016.

(51) Int. Cl. H04N 9/67; H04N 9/64; H04N 9/87; H04N 21/41; H04N 21/4402; H04N 21/45

(52) U.S. Cl. CPC H04N 9/67; H04N 9/643; H04N 21/4516; H04N 21/4135; H04N 21/440218; H04N 9/87

(57) ABSTRACT

Server and client devices and corresponding methods have been realized for adapting delivered video content to the contextual and environmental characteristics surrounding the rendering device. An exemplary client rendering device receives video content having a first dynamic range and a first color gamut. The client device sends a request for transformation information including an identifier for each of the video content and model information of the rendering device. From a server, the client device receives first transformation information for the identified video content and rendering device and uses that information to convert the video content to a converted video content having one of a second dynamic range different from the first dynamic range and a second color gamut different from the first color gamut, so that the converted video content can be played back.

### REFERENCE TO RELATED PROVISIONAL APPLICATION

This application claims priority from U.S. Provisional Application No. 62/435,894 entitled, “METHOD AND APPARATUS FOR CONTEXTUAL COLOR REMAPPING TRANSFORMATION IN CONTENT RENDERING”, filed on Dec. 19, 2016, the contents of which are hereby incorporated by reference in its entirety.

### FIELD OF THE INVENTION

This invention relates to rendering digital video content via color transformations and to providing a service for improving such rendering for the context and environment surrounding the rendering.

### BACKGROUND OF THE INVENTION

Dynamic range and color gamut affect the viewing experience across the wide variety of entertainment scenarios. Disparity between the characteristics of the content and the capabilities of the video devices rendering this content may adversely and inadvertently affect the quality of the ultimate viewing experience.

### SUMMARY OF THE INVENTION

Server and client devices and corresponding methods have been realized for adapting transformation functions and, therefore, rendered video content, for the contextual and environmental characteristics surrounding the rendering device. These devices and methods overcome issues related to rendering device variability for dynamic range and color gamut characteristics and suboptimal rendering of video content that was prepared for an environment and a rendering device that are different from the current context. Use of adapted transformation functions is effective for achieving the proper viewing experience in the current rendering device for its given environment (context).

In one embodiment, the client rendering device performs a method comprising: receiving a video content having one of a first dynamic range and a first color gamut; sending a request for transformation information including an identifier of the video content and an identifier for model information of the rendering device; receiving first transformation information for the identified video content and the identified rendering device; converting the video content, via the first transformation information, to a converted video content having a second dynamic range different from the first dynamic range or a second color gamut different from the first color gamut or both; and playing back the converted video content.

In another embodiment, the web service server performs a method comprising: receiving a request including an identifier of a video content and an identifier of model information of a rendering device, the video content having one of first dynamic range and color gamut; obtaining a first transformation function information according to the identifier of the video content and the model information of the rendering device, the first transformation function information for converting the video content into a converted video content with a second dynamic range and color gamut different from the first dynamic range and color gamut; and sending to the rendering device the first transformation function information.

Additional embodiments define: apparatus including a memory coupled to a processor performing the client rendering device method described above and apparatus including a memory coupled to a processor performing the web service server device method described above.

It should be understood by persons skilled in the art upon a reading of the following description that the present methods and apparatus improve the rendering and presentation of video content based on the context in which the content is shown.

### BRIEF DESCRIPTION OF THE DRAWINGS

The teachings of the present invention can be readily understood by considering the following detailed description in conjunction with the accompanying drawings, in which:

FIG. 1 depicts an exemplary system architecture wherein the client device is a broadcast set-top box;

FIG. 2 depicts an exemplary system architecture wherein the client device is a UHD Blu-ray player;

FIG. 3 depicts an exemplary system architecture wherein the client also includes a service that distributes online movies;

FIG. 4 depicts an exemplary method for contextual color remapping transformation in content rendering and the distribution of the contextual color remapping transformations; and

FIG. 5 depicts an exemplary structure for the client device.

It should be understood that the drawings are for purposes of illustrating the concepts of the subject matter defined in the claims and these drawings are not necessarily the only possible configuration for illustrating this subject matter. To facilitate understanding, identical reference numerals have been used, where possible, to designate identical elements that are common to the figures.

### DETAILED DESCRIPTION

The subject matter disclosed herein describes a system and a method for improving contextual color remapping transformation in content rendering and the distribution of the contextual color remapping transformations. Although the present invention may at times be described primarily within the context of a particular system architecture or rendering technique or rendering device, the specific embodiments of the present inventive method should not be treated as limiting the scope of the inventive subject matter. It will be appreciated by those skilled in the art and informed by the teachings herein that the concepts of the present invention can be advantageously applied for improving substantially any rendering of digital video images.

High-Dynamic Range (HDR) and Wide Color Gamut (WCG) are considered technologies necessary for providing rich color experiences in future entertainment scenarios including UHD (Ultra High Definition) Blu-Ray, 4K video streaming, virtual reality applications, gaming, for example. It is expected that these new entertainment scenarios will be deployed most likely using content and devices operating at 4K resolutions. The terms 4K and UHD indicate resolutions of videos and display devices at 3840×2160.

Video rendering devices today such as televisions and tablets are capable of playing video content in accordance with some minimum requirements for dynamic range and a narrow color gamut. One minimum requirement set for dynamic range is known as Low Dynamic Range (LDR). An exemplary narrow color gamut may approximate the standards set forth in ITU-R Recommendation BT.709.

More recently, devices have been built to support expanded dynamic ranges and wider color gamuts. This trend of building more robust devices confirms the trend expectation that the industry is continuing to migrate video rendering devices toward high dynamic range (HDR), wider color gamuts, and resolutions around 4K.

For dynamic range trends, devices are expected to meet and exceed peak brightness of 1000 nits, while simultaneously rendering black levels at less than 0.03 nits. In terms of color, the trend appears to be toward having devices with hardware capable of rendering approximately a color gamut used for digital cinema applications, which is known as DCI-P3. Eventually, it can be expected that the consumer electronics industry will build devices capable of rendering, with fidelity, the color set defined in a wider gamut known as ITU-R Recommendation BT.2020 for UHD TV.

Despite the availability of standards such as BT.709, DCI-P3 and BT.2020, the color characteristics of rendering devices (such as dynamic range and color gamut) vary within a device itself and across different models. For example, a device may render colors for some tonalities, chroma and hue beyond a particular standard, while that very same device may fail to render other colors for some tonalities, chroma and hue at the level defined by the reference standard. Rendering devices only approximate the color gamuts defined by reference standards. Each device and model typically has its own color gamut characteristics that depends on the hardware and components used to realize the device. The same analysis and conclusion apply for dynamic range. As a result, it is seen that devices may or may not render content in a dependable manner dictated by a particular standard.

In a somewhat similar vein, problems arise in content rendering because of the co-existence of legacy devices with next generation devices and legacy content with next generation content. Legacy Content (LG) can be defined generally as color-graded and/or dynamic-range-graded content targeting current devices that are supporting LDR and BT.709, for example, and that have an HD resolution, although a UHD resolution may be possible but not probable. Next-Generation Content (NG) can be generally defined as color-graded and/or dynamic-range-graded content targeting future devices that are supporting HDR and DCI-P3, for example, with either an HD resolution or a UHD resolution, where the latter resolution is most likely. Legacy content that is prepared for LDR and BT.709, for example, may target current video rendering devices that can be considered as legacy devices or soon-to-be legacy devices. At the same time, next generation content that is prepared to support HDR and WCG would be targeting future or next generation rendering devices. From an industry standpoint, it could be surmised that production and post-production companies will have a fair amount of interest in releasing video assets (i.e., content) that have been color-graded for at least these two classes, namely, legacy and next generation. In view of the availability of many diverse types of rendering devices including TVs, tablets, smart phones, VR (Virtual Reality) headsets, and the like, it is possible that some production companies will distribute video assets with multiple color-graded and/or dynamic-range-graded versions in an attempt to cover as many types of rendering devices as possible.

In this specification, a video asset that is color-graded and/or dynamic-range-graded for legacy rendering devices is denoted as Lᵢ, whereas a video asset that is color-graded and/or dynamic-range-graded to support next-generation rendering devices is denoted as Hᵢ. The index i is used herein to indicate the possibility of having i different color-graded and/or dynamic-range-graded versions of a video asset for legacy rendering devices and i different color-graded and/or dynamic-range-graded versions of that same video asset for next-generation rendering devices.

While only content production and consumption scenarios have considered above, these and other issues/problems arise in the area of movie content distribution. In content distribution, there is a source and a target for the distributed content. A source sends content to a target using one of several different approaches: a one-to-many approach such as broadcasting; a one-to-one approach that is used in internet video distribution; and a combination of both approaches.

A distribution source such as a TV station can broadcast a particular video asset as LG content or as NG content or as a simultaneous broadcast of both types of content, LG and NG. NG content not only provides higher quality content than LG content, but it also requires more transmission bandwidth to reach the target. Broadcasters typically have a limitation on the bandwidth available for transmission. So it is highly likely that in practice a broadcast TV station will transmit the video asset using either LG content or NG content, but not both, in order to meet the transmission bandwidth limitation. But if a TV station broadcasts a video asset as NG content, there is a problem when the renderer supports only LG content. Similarly, if a TV station broadcasts a video asset as LG content, there is another problem when the renderer supports only NG content. These problems require significant attention as the transition moves along from LG content to NG content.

Distribution of the content or video assets on portable media, such as optical disks (e.g., Blu-ray disks) and the like, faces problems similar to those discussed above for broadcast TV stations. In the portable media case, the source is a production company. When producing the video asset on the portable medium, the production company can choose to include the video asset on the disk as LG content or as NG content or as both LG content and NG content. It can be appreciated that, because of the high-resolution and high-quality of NG content, the NG presentation of a video asset will most likely be larger than the LG presentation of the same asset, in terms of allocated storage area on the disk. As such, it is highly likely that in practice a production company will produce the video asset on the portable medium using either LG content or NG content, but not both, in order to meet the storage limitations of the medium. But if a production company includes a video asset as NG content in a Blu-ray disk, there is a problem when the renderer supports only LG content. Similarly, if the included video asset is LG content on the portable optical medium, there is another problem when the renderer supports only NG. Again, these problems require significant attention as the transition moves forward from LG content to NG content.

In the case of online video distribution, the distributor will have the choice to store each video asset as LG content, as NG content, or as both LG and NG content. A target rendering device can then request content from the online distribution server to meet the exact capability of the target device, and, optionally, the specific viewing environment around this target device. That is, a rendering device capable of playing LG content can request that exact version of the asset from the distribution server. But because storage of large typically uncompressed assets is expensive, some video distributors may prefer to simply store either LG content or NG content but not both versions on its servers. When an online distributor stores a video asset as NG content in storage servers, a problem arises the server needs to fulfill a request from to a rendering client that supports only LG content. Similarly, when a stored video asset exists as LG content on the distribution server, a different problem arises in fulfilling a request from a client device that renders only NG content. Yet again, these problems require significant attention as the transition moves forward from LG content to NG content.

These problems can be addressed by different alternative approaches. One such approach involves the use of reference-based color and/or tone remapping, which employs at least one color version as a reference for deriving the other color version(s) through a color and/or tone remapping procedure (color/tone mapping).

For example, a movie production company can generate at least two high-quality color-graded versions of the content: one version that targets rendering devices that play LG content, and another version that targets rendering devices that play NG content. Both of these high-quality color graded versions constitute the reference content, which are designated as L₀ for the LG content and H₀ for the NG content. Each version of the reference content includes an ordered sequence of pictures for display at some specific presentation time. The ordered sequences are written as follows:

L₀={L₀(i,j,k),f or i∈[1,2, . . . N_{L}],j∈[1,2, . . . M_{L}],k∈[1,2, . . . K_{L}]} (1), and

H₀={H₀(i,j,k),f or i∈[1,2, . . . N_{H}],j∈[1,2, . . . M_{H}],k∈[1,2, . . . K_{H}]} (2),

where the index k to specify a particular image sample in the sequence and indices i and j denote the row and column index of a pixel. The pixel elements defined as L₀(i,j,k) and H₀(i,j,k) constitute a vector of 3 values, where each value defines a color and tone level. The color level values are defined as representations using the RGB color space of a rendering device (that may be defined in a standard), the YCbCr space, or any other suitable color space.

The resolution of L₀ for the LG content is N_{L}×M_{L} and the resolution of H₀ for the NG content is N_{H}×M_{H}. It is contemplated that both reference sequences can have the same resolution or they can have different resolutions. For example, it is possible that the reference for LG content is HD, while the reference for NG content is UHD.

The two reference sequences L₀ and H₀ represent the same movie content without any scene additions or removals. As such, both sequences result in a fixed duration movie. While it is quite likely that both versions will have a similar number of pictures; that is, K_{L} for L₀ and K_{H} for H₀, where K_{L}≠K_{H}, it is possible that for some external reason the two video assets do not have perfect time alignment. In this latter case, the number of pictures in the two sequences are different and K_{L}≠K_{H}.

A color/tone-remapping transformation is defined as a collection of spatial-temporal functions that map H₀ content into an approximate version of L₀ content. In other words, a color/tone-remapping transformation is defined as a set of functions T_{0,d}(⋅) such that L′₀(i,j,k)=T_{0,d}[H₀(i,j,k)] and L₀(i,j,k)≈L′₀(i,j,k). The sub-index 0 indicates that the transformation function relates the color-graded next-generation content H₀ with the legacy content L₀. The sub-index d indicates that there are many transformation functions that are used simultaneously to perform the color/tone mapping transformation.

An inverse color/tone-remapping transformation performs the opposite operation from the one described immediately above. That is, when the inverse transformation is applied to L₀ content, the result is an approximation to the HDR/WCG version H₀, which is shown mathematically as follows:

H′₀(i,j,k)=T_{0,d}⁻¹[L₀(i,j,k)] and H₀(i,j,k)≈H′₀(i,j,k).

Generally, one color/tone transformation function is allocated to a frame, in which case, d=k. However, it is contemplated to have fewer transformation functions allocated per frame. In other words; it is possible to design a single transformation function per scene. On the other hand, it is also possible to design more transformation functions than frames; such as, transformation functions designed to apply to regions within a single frame.

In this application, it is understood that these transformation functions exist and are well-known. While no particular transformation or design method is advocated herein, it is understood that persons skilled in this art may impose certain design constraints on the type and applicability of the transformation functions.

With constraints in place, the transformation functions can be determined by solving an optimization problem that maximizes a similarity measure between L₀ and L′₀, as well as H₀ and H′₀.

The design of the color/tone transformation functions can be developed in any manner and subject to any number of constraints. In one non-limiting exemplary technique, the design procedure utilizes three exemplary constraints, as described below.

The first exemplary constraint is that a single color/tone transformation function typically consists of three composite operations: (1) a piecewise-linear map applied to each color component of a pixel; (2) a linear combination of the results using a 3×3 matrix; and (3) a second piecewise-linear map applied to the 3 resulting linearly combined components to generate the output colors for each pixel.

Secondly, a single transformation function is to be used to map one H₀ frame into one L′₀ frame. The coefficients that define a single transformation function are obtained as the set of coefficients that minimizes the sum of squared errors between an L′₀ frame and the matching L₀ frame.

Thirdly, the transformation function designed for a particular frame can remain constant for a group of consecutive frames. In other words, it is possible that a single transformation function remains viable for transforming more than one frame.

Color/tone transformation functions may be parametric. For example, color/tone transformation functions can use a model like the piecewise linear maps discussed above. Alternatively, transformation functions may be non-parametric and employ a machine learning algorithm that defines a transformation based on decision trees, for example.

Color/tone transformation functions can be applied to multiple frames, one frame, or a sub-region of a frame. In one example, a transformation function can be applied to a group of frames. In another example, the transformation function can be applied to a single frame. In the final case, multiple transformation functions are active for a particular frame in order to transform all the sub-regions of that frame.

Each color/tone transformation function is preferably invertible; in which case the inverse transformation function T_{0,d}⁻¹(⋅) is readily available for the transformation function T_{0,d}(⋅). If the transformation function is not directly invertible, then the inverse transformation function T_{0,d}⁻¹(⋅) function can be obtained using an approximation procedure that minimizes an error function as already described above.

Beyond the issues facing color/tone transformation function in general, there are additional issues that arise based solely on the viewing context (i.e., environment) in which the rendering takes place (as contrasted with the context in which the color-grading was performed). Baseline transformation functions can often produce suboptimal results for the viewer for any number of reasons.

One reason discussed already above involves heterogeneous rendering device support for color gamuts and dynamic ranges. Another reason for a suboptimal viewing experience is that different brands and models of rendering devices support color gamuts and dynamic ranges that do not match the standard color gamuts, the dynamic ranges, and the reference display devices used and assumed when color grading the different version of the content.

Additionally, viewing environments used for color grading can be significantly different from the viewing environments for the actual rendering devices. For example, while color-grading generally occurs in a relatively dark environment, the target rendering devices may be operating frequently in bright daylight environments.

Furthermore, the viewing experience can be adversely impacted because the user may have changed brightness, contrast, and color levels in a rendering device due to environment conditions or to satisfy personal viewing preferences. In this example, the device rendering characteristics at view time can differ from the target assumptions made during color grading due to these changes of settings of the actual rendering device.

Finally, mobility of the rendering device allows the user to change locations for the rendering device and thereby change the viewing environment for the content, all while watching the same content stream. Change in location for the rendering device alters the viewing environment for the content.

It has been determined by us that the problems discussed above can be mitigated by a mechanism, means, or process that adapts the color/tone transformation functions to match more closely the contextual characteristics of the target device. It is assumed that a family of color/tone transformation functions T_{0,d}(⋅) can be adjusted to match the current context (i.e., environment) surrounding the target rendering device. Given that T_{0,d}(⋅) represents the transformation functions necessary to convert H₀ into L′₀, as described in the equations above, it is possible to modify the functions in a way that will make these transformations suitable for and adaptable to different contexts or environments.

For example, color/tone transformation function(s) T_{1,d}(⋅) can be the modified transformation function(s) that converts H₀ into L′₀ and corrects for a different color space in a rendering device of a particular brand and a particular model; transformation function(s) T_{2,d}(⋅) can be a modified transformation function(s) that converts H₀ into L′₀ and corrects for viewing conditions in bright environments; transformation function(s) T_{3,d}(⋅) can be a modified transformation function(s) that converts H₀ into L′₀ and corrects for viewing conditions in very dark environments; and so on.

The use of modified color/tone transformation functions to achieve the proper viewing experience in the rendering device for its given environment or context at the time is extremely cost effective. For content producers and the like, the process of color grading is an expensive operation that requires significant training and experience. Production companies can be expected to color grade only a few versions of a content like legacy and next-generation content versions in order to maintain price points and cost control. Obviously, it is a very expensive and labor intensive effort to color grade content for every rendering device, by its brand and model, and for every environmental condition or significant change in environmental conditions.

It is contemplated that contextual color/tone transformation functions can be realized by technicians or operators making manually adjustments the transformation functions in order to match the color and dynamic range characteristics of the target, that is, the rendering device in its current contextual environment. Alternatively, it is contemplated that these contextual transformation functions may be realized by using quality metric software that provides feedback and adjusts the functions automatically to match the color and dynamic range characteristics of the target, that is, the rendering device in its current contextual environment. Consistent with the description above, it is apparent that the terms “context” and “environment” and their derivative terms have been used interchangeably without limitation or modification.

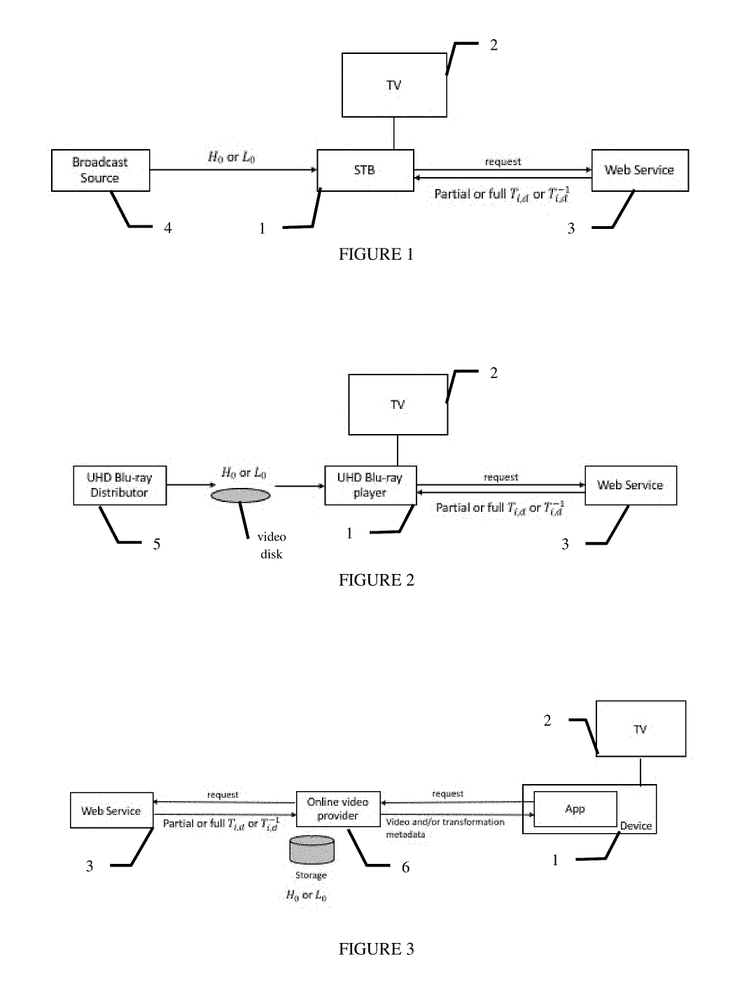

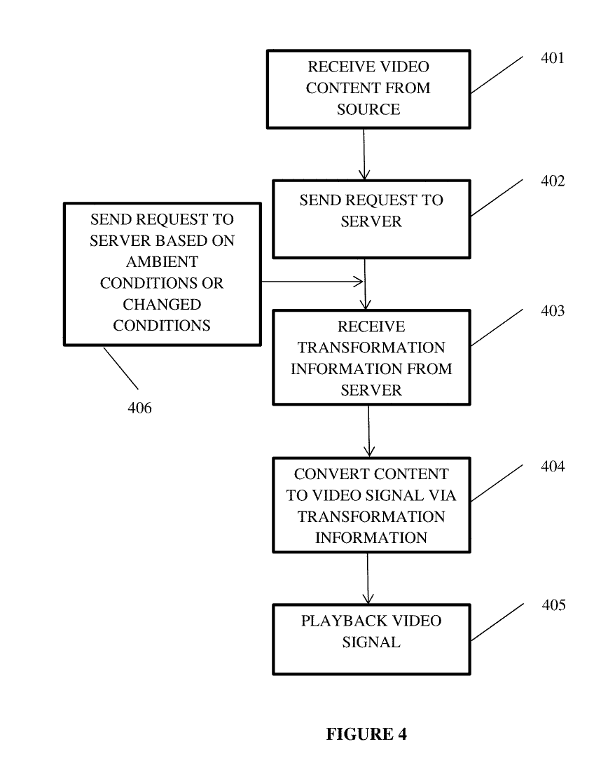

FIGS. 1-3 depict exemplary system designs for a service that, upon request, distributes color and/or tone remapping transformation functions to client rendering devices in order to adapt rendering of the desired content for the target client rendering device and/or viewing environment. FIG. 1 depicts an exemplary system architecture wherein the client device 1 is realized as a broadcast set-top box; FIG. 2 depicts an exemplary system architecture wherein the client device 1 is realized as a UHD Blu-ray player; and FIG. 3 depicts an exemplary system architecture wherein the client also includes a service that distributes online movies. FIG. 4 shows a flowchart for the various operations performed by the client device 1 with reference to the other devices in the exemplary systems of FIGS. 1-3. The description of FIGS. 1-3 below also includes references to the sequence of operations shown in FIG. 4.

The client device and the web service (server) can be realized in various embodiments. While hardware and hardware/software/firmware embodiments can be achieved, an exemplary embodiment can include a memory that stores a plurality of instructions and a processor coupled to the memory and configured to execute the instructions to perform an appropriate method, such as a client device based method for the client device embodiment and a web service (server) based method for the web service (server) embodiment.

A client device may include a non-transitory computer readable storage medium for storing computer executable instructions implementing, for example, the process shown in FIG. 4.

In FIG. 1, a client device 1, such as a set-top box (STB), plays a movie via its connection to a TV 2 (step 405). The client device is configured to communicate, via an input/output port, with the TV to obtain identifying information such as brand name and model information (step 402). This represents one form of contextual information for rendering the content. It should be understood that additional contextual information concerning characteristics and settings of the TV may also be obtained, where possible and necessary, in the identifying information. In addition, the client device can obtain measurements for other environmental (i.e., contextual) conditions at the time that the content is being viewed. These conditions measurements can be obtained by devices connected to the client device itself such as the TV or a camera or sensors and other such external devices that are capable of gathering the environmental condition information. Exemplary conditions for which measurements can be gathered include, but are not limited to, ambient lighting conditions such as brightness and darkness levels in the viewing area, contrast level settings for the TV, and the like. Any of this information about the environmental condition(s) can be included in the request from the client device.

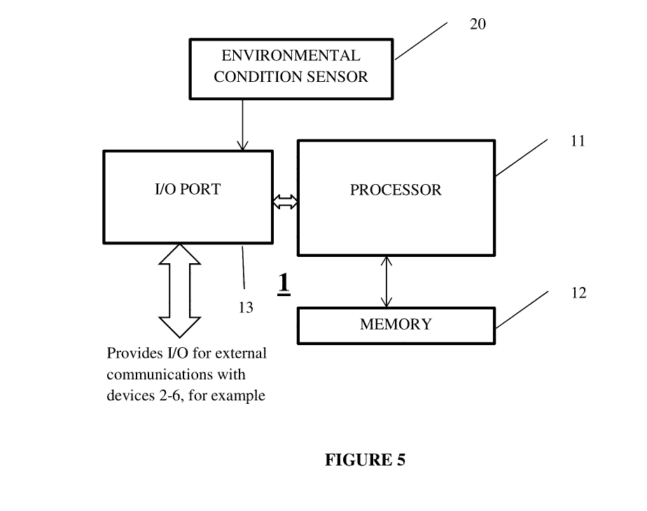

An exemplary client device 1 is depicted in FIG. 5. Client device 1 is shown connected to an environmental condition sensor 20. Client device 1 includes a processor 11, a memory 12, and an input/output port 13. Processor 11 is coupled to memory 12, which stores information and instructions that are capable of being used and executed by the processor. The processor 11 communicates with external devices and systems through the I/O port 13. I/O port 13 provides a communicative coupling between the client device 1 and external devices/systems such as those shown in FIGS. 1-3 together with any additional devices providing environmental sensing (e.g., sensor 20). The I/O port is used for sending requests including the identification of a requested video content, the identification for model of the STB and/or rendering device, and the environmental condition such as an ambient lighting condition. I/O port 13 is also used for receiving video content and transformation information among other communications.

FIG. 4 shows the different steps 401 to 406 of the below process.

Client device 1 receives, via its input output port 13, content video frames in the stream H₀ or L₀ from broadcast source 4 and proceeds to decode the content video frames for playback on TV 2 (step 401). The received video frame stream includes content having a first dynamic range and a first color gamut as described above.

Client device 1 connects, via its input output port 13, with the web service 3 in order to request the contextual color/tone transformation data (step 402). The request includes at least information that identifies at least the display device, that is, TV 2, and the video content being rendered. As mentioned above, this information can also include information that conveys the settings of the TV such as contrast level, brightness level, and the like together with information about the ambient lighting condition in the viewing area, i.e. about the viewing environment.

Web service 3 responds to the request by sending color/tone transformation information (that is, color/tone transformation function information) particularized at least for the identified video content and the identified rendering device (step 403). Web service 3 may be embodied as a server device. When additional information related to viewing environment such as ambient conditions for lighting and the like is received in the request, the color/tone transformation information from the web service is further particularized for that additional information (steps 406 and 403). When no additional information is included in a request, the web service is configured or operative to transmit color/tone transformation information using defaults for the additional information such as, for example, bright for the ambient lighting condition.

Web service 3 obtains color/tone transformation function information according to the identifiers in the received request including the identifier of the video content and the model information of the rendering device. An identification of a requested video content and an identification for model of the STB and/or rendering device may associate with one or more color/tone transformations. If an identification of a requested video content and an identification for model of the STB and/or rendering device associate with only one color/tone transformation, additional information is not needed. However, if an identification of a requested video content and an identification for model of the STB and/or rendering device associate with more than one transformation, additional information such as ambient viewing condition is considered. In any case, a color/tone transformation function is associated with if an identification of a requested video content and an identification for model of the STB and/or rendering device. Thus, the obtained color/tone transformation function information is associated with the identified requested video content and the identified rendering device.

The web service 3 may have the information stored locally with the web service 3 or available from an affiliated source. From the client device's perspective, the request is being fulfilled by the web service 3 alone without any knowledge of the actual source of the transformation function information.

According to its specific realization, the color/tone transformation information is configured to apply to:
all the video content being delivered to the client device; or
particular portions of the video content such as a sequence of two or more frames; or
a particular frame of the video content; or
a particular region of a frame of the video content.

Typically and preferably, this transformation information is received during the playback of the video content. The transformation information can be received from the web service in a sequence of fragments over time or in bulk as a bundle via a single download transfer from the web service. As shown in the figures, the color/tone transformation information can be full or partial contextual transformation functions or inverse transformation functions such as T_{i,d} or T⁻¹_{i,d} of the type of function discussed above, where 1=0, 1, 2, 3 . . . .

As the color/tone transformation information is received by client device 1 (step 403), it is used to convert the color and/or tone of video content to a converted video content having a second dynamic range and/or a second color gamut that is different from the first dynamic range and/or the first color gamut for the content (and its converted video content) as it was originally received from broadcast source 4 (step 404).

In general, the transformation information can be identified to apply to its given portion (or entirety) of the frame sequence for the video content. By corresponding the color/tone transformation information to the appropriate portion of the frame sequence of the video content, it can be assured that the proper part of the video content is converted in the client device by the proper part of the received transformation information.

Once the video content has been converted using the color/tone transformation information, the converted video content is sent to the TV 2 for play back (step 405).

As contextual and/or viewing conditions change, such as with changes in ambient lighting levels, it is possible for the client device to sense those changes and to include an indication of these change in the request of step 402 or to formulate a new request including this indication for the web service (step 406). In turn, the web service can respond to the request with updated color/tone transformation information that can be used to convert the remaining video content to a new converted video content whose dynamic range and color gamut is different from the second dynamic range and color gamut. This updating process can continue until the video content rendering is completed.

In FIG. 2, the broadcast source is replaced by a UHD Blu-ray distributor 5 that distributes UHD Blu-ray video content on optical video disk, as shown. The client device is therefore a Blu-ray disk player that retrieves content video frames in the stream H₀ (or L₀) from the Blu-ray disk as distributed.

In FIG. 3, the client device can request the transformation information from the online video provider service 6. Provider 6 then forwards the request to a web service 3 that responds with the aforementioned color/tone transformation information. In turn, client device 1 can receive from provider 6 the content, which has been converted by the provider using the received color/tone transformation information. Alternatively, the provider 6 can supply color/tone transformation metadata to the client device 1. Supplemented by an application running in the client device, it is possible to use the received transformation metadata to perform the conversion of the content per step 404.

One typical implementation for these systems and the method involves having the client device request the color/tone transformation information in progressive mode. By employing a progressive mode, the client device receives transformation color/tone information for a particular data segment (i.e., frame(s) of video content) before the frames for the particular segment are rendered. The client device may choose to receive the color/tone transformation in a batch mode so that the entirety of color/tone transformation information for the entire amount of video content is received by the client device in response to the request. In this way, the totality of the color/tone transformation data is downloaded to the client device in advance for later use.

As mentioned above, client devices acquire color/tone transformation information data in either batch mode or progressive mode. In an example of batch mode acquisition and delivery of color/tone transformation information, a client device can request a particular type of color/tone transformation function that applies to all the frames in the video asset. This color/tone transformation type is selected from all the options available for the movie. The client applies the downloaded color/tone transformation functions, frame by frame, at the time of content rendering. In an example of progressive mode acquisition and delivery of color/tone transformation information, client devices can request a particular type of color/tone transformation information for a fragment of a video asset. The downloaded color/tone transformation functions can then be applied to the video during playback of the particular fragment, whether the fragment is a frame, a group of frames, or a portion or region in a frame.

One benefit from using the progressive mode is that it allows client devices to request different color/tone transformations for different segments in a movie. For example, if the client device is a portable device such as a mobile phone operating at first in a poorly lit place, the device may request initially a color/tone transformation type optimized for dark viewing environments. Then at a later time, when the user moves the portable device into a brighter viewing environment, the client device can request the color/tone transformation functions applicable to this new context such as a color/tone transformation type optimized for brighter environments.

The process depicted in FIG. 4 starts when the client prepares to play the movie and ends when the client displays the last frame of the movie.

In transmitting and receiving any color/tone transformation information including updated color/tone transformation information pursuant to a client device request, it is contemplated that the color/tone transformation information being provided is in a form that shows the difference(s) or delta(s) between the immediately preceding color/tone transformation information and the color/tone transformation information that is currently being provided. In this mode, the color/tone information for frame X+1 can be transferred as delta values (difference amounts) from similar values for frame X. By providing the changed color/tone transformation information in this way, it is possible to reduce both transmission bandwidth usage and the time to deliver color/tone transformation information for the client device's use.

Given the potentially large amounts of data being transmitted in the color/tone transformation information, it may be desirable and even required, in some cases, to employ data compression/decompression techniques on the color/tone transformation information conveyed between the web server and the client device in the systems and method discussed above.

The web service is configured to store or have readily available color/tone transformation information (metadata) for a collection of video content such as movies. A video content identifier is necessary to uniquely isolate movie information as well as the associated color/tone transformation information in the database. Different identifiers can be used to describe the same video content. For examples, different identifiers for the same video content (movie) may identify such different variants as a director's cut, a theatrical release, a release in a particular geographical market, and so on.

The web service is capable of storing color/tone transformation information for video content sourced by multiple movie distributors (providers). In this example, the web service maintains provider information identified uniquely by a provider ID that can be associated with a particular version of the video content.

For each movie that is stored by the service, the web service is also capable of storing different types of color/tone transformation functions. For example, the service may store any or all of piecewise-linear transformations and polynomial transformations. Moreover, for each movie and each transformation type, it is expected that the web service stores the direct and inverse baseline transformations, namely, T_{0,d}(⋅) and T_{0,d}⁻¹(⋅). In addition, the web service stores zero or more contextual transformations functions T_{i,d}(⋅) where i=1, 2, 3 . . . .

Client devices that connect to the web service request to download color/tone transformation functions using service and movie identifiers. It is further contemplated that client devices can be configured to use one or more frame numbers as identifying indices to retrieve the applicable color/tone transformation functions used to convert the identified frame(s).

The techniques and systems described in this application can be implemented to use non-relational databases or relational databases, such as SQL, to store color/tone transformation information (metadata) associated with the video content being rendered. In one embodiment, data collections are described using JavaScript Object Notation (JSON), which can be easily implemented in open source, non-relational database systems such as MongoDB, which is developed by Mongo DB Inc. For these data collections exemplary movie and transformation schema are shown below.

### For the Movie Schema:

```
Movie_Collection = {
  ... one or more Movie_Entry objects ...
}
Movie_Entry = {
  “Generic_Movie_ID”: <unique ID across service providers (string)>,
  “Scoped_Movie_ID”: {
      “Service_Provider_ID”: <unique ID identifying a service provider
(string)>,
      “Assigned_Movie_ID”: <unique ID identifying a movie within the
provider scope (string)>
  }
  “General_Metadata”: {
    “Number_Frames”: <number of frames in this instance of a movie
(int)>.
    ... zero or more additional metadata entries like Title, Duration, etc....
  }
  “Applicable_Transformations”: {
    “Transformation_ID”: <identifier string for a transformation defined
for this movie (string)>,
    ... 0 or more Transformation_ID values}
}
```

### For the Transformation Schema:

```
Transformation_Collection = {
  ... one or more Transformation_Entry objects ...
}
Transformation_Entry = {
  “Transformation_ID”: <unique ID value that identifies this transformation
(string)>,
  “Transformation_Type”: <unique value that identifiers the type of this
                      transformation (string)>
  “Applicability”: {
    “Context_List”: [ <list of strings identifying the applicable context conditions> ],
    “Device_List”: [ <list of Device objects identifying the applicable devices> ]
  },
  “Frames”: {
    “0”: { ... one Parameter Bundle or one Replicate object ... },
    “1”: { ... one Parameter Bundle or one Replicate object ...},
    ... etc., Include information for all relevant frames.
          However, not all frames need entries ...
    }
  }
}
Device = {
  “Brand”: <unique ID value that identifies a device brand (string)>,
  “Model”: <unique ID value that identifies a model within a brand (string)>
}
Parameter_Bundle = {
“Parameter_Set”: {
```

| | |
|---|---|
| “Region”: [x0, y0, x1, y1], | // A region within the image. |
| | //The four values are floating point numbers |
| | //between 0 and 1. Dimensions ‘x’ and ‘y’ refer |
| | // to horizontal and vertical coordinates |
| | // measured from the top-left corner |
| | // Values 0, 0, 1, 1 represent the region that |
| | //covers all the frame. |

```
    “Constants”: [<list of zero or more constants necessary to implement the
                transformation>].
    “Coefficients”: {
      “Group”: <group number (integer). Starts with 0>,
      “Values”: [ <list of coefficient values (integer or floats)> ]
    }
    ... zero or more Coefficients objects as required to describe this region ...
  }
  ... zero or more applicable Parameter Set objects to describe other regions in
    this frame ...
}
Replicate = {
  “Frame_Index”: <frame index for the frame from which metadata can be
replicated>
}
```

An exemplary list of values for the Context_List can be defined for the protocol as follows: very_bright, bright, dark, very_dark, high_tv_contrast, low_tv_contrast, and so on. These values refer to ambient conditions for lighting and contrast. Ambient lighting condition can be detected using conventional methods, for example, using one or more cameras or light sensors or the like, such as environmental condition sensor 13, attached to the client device 1 and in proximity of or positioned around the client device. Similarly, an initial list of device models and brands can be defined for the protocol because consumer electronics manufacturers tend to precisely define their brand names and model numbers.

The lists of values for the Context_List and values for the Device_List, and the collection of transformation information are not limited to the examples shown above. It is contemplated that these values and information can be expanded, enhanced, corrected, or modified at any time.

The Coefficients data structure is used above to store transformation coefficients for parametric transformations. The most common form of non-parametric transformation is a rule based system. In this case, the Coefficients data structure can be replaced by a similar structure conveying the rules that apply to particular regions of the image. The rules will use a syntax similar to that found in Prolog or other logic languages.

The data structures defined above using JSON can be easily extended with additional fields as necessary.

The following section of this disclosure provides an exemplary definition for a Representational State (REST) protocol that client devices can use to acquire transformation information from the proposed web service.

The exemplary REST Application Programming Interfaces (API) defined here use HTTP/1.1 POST methods. The POST method is used to request that the origin server accept the entity enclosed in the request as a new subordinate of the resource identified by the Request-Uniform Resource Identifier (URI) in the Request-Line. The actual function performed by the POST method is determined by the related server and is usually dependent on the Request-URI. The posted entity is subordinate to that URI in the same way that a file is subordinate to a directory containing it, a news article is subordinate to a newsgroup to which it is posted, or a record is subordinate to a database.

The exemplary APIs can be rewritten using GET methods or using other communication protocols. The GET method means that the information (in the form of an entity) is identified by the Request-URI is the information that is retrieved. In one example, when the Request-URI refers to a data-producing process, it is the produced data that is returned as the entity in the response and not the source text of the process, unless that text happens to be the output of the process.

The exemplary protocols defined below are used to retrieve transformation metadata, when such retrieval action is necessary. If there is no need to perform a transformation as a result, for example, of the occurrence of matching characteristics between content and target device, the client device and server will not use the protocol and therefore will not transfer transformation information.

It should be understood that the exemplary protocols defined below are intended to be independent of any other protocol that governs the request and download a movie, particularly in the case of online service providers.

The following protocol is provided as an exemplary protocol related to a request for all metadata for certain context conditions:

```
POST <service_url>/get_transform?mode=batch
Payload:
{
  “Request_ID”: <a unique ID (string) that identifies this request. It
should contain
                a time stamp>
  “Service_Provider ID”: <unique ID identifying a service provider
(string)>,
  “Assigned_Movie ID”: <unique ID identifying a movie within the
provider
                      scope (string)>,
  “Requested_Content_Type”: <(string) either ‘LG’ or ‘NG’>
  “Context”: [list of measured context conditions>],
                      // zero or one Context element. The list can
                      // have multiple values
  “Device”: { // zero or one Device entry
    “Brand”: <brand name of connected display device>,
    “Model”: <model number of connected display device>
  }
}
```

Upon receiving this request, the web service server attempts to match the data in Conditions with the data in the Applicability element of Transformation Entry objects in the database. The matching does not need to be a perfect match across all possible elements. If there is ambiguity in the data, the server can be configured to select the proper or closest transformation information using a best effort approach.

If the web service server successfully processes the request, it can return an HTTP return message with a 200 status code carrying one of the following payloads:

```
{
  “Request_ID”: <the unique ID reported in the request message>,
  “Transformation”: “Unknown”
  “Message”: <Friendly error message for display>
}
{
  “Request_ID”: <the unique ID reported in the request message>
  “Transformation”: <unique ID value retrieved from the database>
  “Frames”: {
    “0”: { ... one Parameter_Bundle or one Replicate object ... },
    “1”: { ... one Parameter_Bundle or one Replicate object ...},
    ... etc., Include information for all relevant frames.
        However, not all frames need entries ...
  }
}
```

The Parameter_Bundle and Replicate objects carry the information defined above. If the web service server cannot successfully process the request, it returns a 4XX or 5XX code identifying the probable cause of error.

The following exemplary protocol is provided as an exemplary protocol related to an initial request for downloading transformation metadata by fragments. The first request for fragmented metadata defines baseline information that can be used in subsequent requests:

```
POST <service_url>/get_transform?mode=setup_fragment
Payload:
{
  “Request_ID”: <a unique ID (string) that identifies this request. It
should contain
                a time stamp>
  “Service_Provider_ID”: <unique ID identifying a service provider
(string)>,
  “Assigned_Movie_ID”: <unique ID identifying a movie within the
provider scope
                        (string)>,
  “Requested_Content_Type”: <(string) either ‘LG’ or ‘NG’>
  “Device”: { // zero or one Device entry
    “Brand”: <brand name of connected display device>,
    “Model”: <model number of connected display device>
  }
}
If a web service server successfully processes the request, it can return
an HTTP response message with status code 200 carrying the
following payload:
{
  “Request ID”: <the unique ID reported in the request message>
  “Session ID”: <a unique ID that a client uses to request fragments of
              transformation metadata>
  “Number Frames”: <the total number of frames for this movie instance>
}
```

The client device reuses the Session ID to request any subsequent transformation metadata. The web service server maintains a list of sessions, which can help the server anticipate future requests from the client device. If a web service server cannot successfully process the request, it returns an HTTP response message with a 4XX or 5XX code identifying the probable cause of error.

The following exemplary protocol is provided as an exemplary protocol related to one or more subsequent request for downloading transformation metadata by fragments. After the initial set-up request described above, the client device sends requests to download transformation metadata for a fragment of the video content asset using:

```
POST <service_url>/get_transform?mode=fragment
Payload:
{
  “Session_ID”: <The unique ID value (string) that identifies the
session for
              fragment downloading>
  “Request_ID”: <a unique ID (string) that identifies this request.
It should contain
              a time stamp>
  “Context”: <list of measured context conditions ... zero or one
Context element.
            The list can have multiple values>
  “Start_Frame”: < The ordinal index for a frame (integer). First
frame index is 0>
  “Final_Frame”: <the ordinal index for a frame (integer)>
}
```

Upon receiving this subsequent request, the web service server matches the data in Conditions with the data in the Applicability element of Transformation Entry objects in the database. Again, the matching does not need to be perfect. If there is ambiguity in the data, the web service server can select the proper transformation using a best effort approach. The web service server then returns the transformation metadata for the requested segment, if it is available. If the server successfully processes the request, it returns an HTTP return message with a 200 status code carrying one of the following payloads:

```
{
  “Request_ID”: <the unique ID reported in the request message>,
  “Session_ID”: <The unique ID value (string) that identifies the
session for
              fragment downloading >
  “Transformation”: “Unknown”
  “Message”: <Friendly error message for display>
}
{
  “Request_ID”: <the unique ID reported in the request message>
  “Session_ID”: <Unique ID value (string) that identifies session for
fragment
                downloading >
  “Start_Frame”: < the ordinal index for a frame (integer). First frame
index is 0>,
  “Final_Frame”: <the ordinal index for a frame (integer)>
  “Transformation”: <unique ID value retrieved from the database>
  “Frames”: {
    “X”: { ... one Parameter Bundle object ... },
    “X+1”: { ... one Parameter Bundle object ...},
    ... etc., Include information for all requested frames. However, not
all frames
          need entries ...
        }
}
```

In the above structure, the value X corresponds to the Start_Frame index. If the Start_Frame index does not have transformation metadata, then X represents the first frame in the fragment that contains this information.

The Parameter_Bundle carries the information defined above. It should be understood that, in this example, the response cannot include a Replicate object. If the database shows a Replicate object for one of the frames, the server must replicate the data at the time of sending the response. If the server cannot successfully process the request it returns a 4XX or 5XX code identifying the probable cause of error.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudo-code, and the like represent various processes which may be substantially represented in computer readable media and so executed by a computer or processor, whether or not such computer or processor is explicitly shown.

Having described various embodiments for rendering digital video content via color transformations and to providing a service for improving such rendering based on the context or environment surrounding the rendering, it is noted that modifications and variations of the method can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

We claim:

1. A method comprising:
receiving a video content having a first dynamic range and a first color gamut;
sending a first request for color/tone transformation information, wherein the request includes an identifier of the video content and an identifier for model information of a rendering device;
receiving first color/tone transformation information for the video content and for the rendering device; and
by utilizing the first color/tone transformation, converting the video content to a converted video content having a second dynamic range different from the first dynamic range, or a second color gamut different from the first color gamut, or both.

2. The method of claim 1, further comprising:
detecting a change in viewing conditions around the rendering device;
wherein said first request further includes an indication of the change in the viewing conditions, and
wherein received first color/tone transformation information is further for said change in viewing conditions.

3. The method of claim 1, further comprising:
detecting a change in viewing conditions around the rendering device;
sending a second request including an indication of the change in the viewing conditions;
receiving second color/tone transformation information based on the change in the viewing conditions for the rendering device; and
converting remaining unconverted video content of said video content to the converted video content by utilizing the second color/tone transformation information.

4. The method of claim 3, wherein said receiving further includes replacing the first transformation information with the second transformation information.

5. The method of claim 1, wherein the model information of the rendering device includes at least one of a brand name and a model.

6. The method of claim 1, wherein sending comprises sending to a web server.

7. The method of claim 1, wherein the first color/tone transformation information includes color/tone transformation information for one or more frames in the video content and the receiving comprises receiving the first color/tone transformation information for the one or more frames during playback of the converted video content.

8. The method of claim 1, wherein the first color/tone transformation information comprises one or more transformation parameter bundles for converting all frames in the video content.

9. The method of claim 8, wherein a first color/tone transformation parameter bundle of said plurality of transformation parameter bundles is applicable for converting a plurality of frames of the video content.

10. The method of claim 1, further comprising receiving a session identifier in response to the request, wherein the session identifier is configured to be included in a second or subsequent request by the rendering device in relation to the received video content.

11. Apparatus comprising:
a memory that stores a plurality of instructions; and
a processor coupled to the memory and configured to execute the instructions to:
receive a video content having a first dynamic range and a first color gamut;
sending a first request for color/tone transformation information, wherein the request includes an identifier of the video content and an identifier for model information of a rendering device,
receive first color/tone transformation information for the video content and for the rendering device; and
by utilizing the first color/tone transformation, convert the video content to a converted video content having a second dynamic range different from the first dynamic range, or a second color gamut different from the first color gamut, or both.

12. The apparatus of claim 11 wherein said instructions further comprises:
detecting a change in viewing conditions around the rendering device;
wherein said first request further includes an indication of the change in the viewing conditions, and
wherein received first color/tone transformation information is further for said change in viewing conditions.

13. A method comprising:
receiving a request including an identifier of a video content and an identifier of model information of a rendering device, the video content having one of first dynamic range and color gamut;
obtaining a first transformation function information according to the identifier of the video content and the model information of the rendering device, the first transformation function information for converting the video content into a converted video content with a second dynamic range different from the first dynamic range, or a second color gamut different from the first color gamut, or both; and
sending to the rendering device the first transformation function information.

14. The method of claim 13, further comprising:
receiving an indication of change in an ambient lighting condition at the rendering device;
sending second transformation information based on the change in the ambient lighting condition for the identified rendering device in order to allow the rendering device to convert remaining unconverted video content of said video content to a converted video content by utilizing the second transformation information.

15. The method of claim 14, wherein the second transformation information is sent as a replacement for the first transformation information.

16. The method of claim 13, wherein the model information of the rendering device includes at least one of a brand name and a model.

17. The method of claim 13, wherein the first transformation information includes transformation information for one or more frames in the video content and the sending comprises sending the first transformation information for the one or more frames during playback of the converted video content at the rendering device.

18. The method of claim 13, wherein the first transformation information comprises one or more transformation parameter bundles that are sufficient for converting all frames in the video content.

19. The method of claim 18, wherein a first transformation parameter bundle of said plurality of transformation parameter bundles is applicable for converting a plurality of frames of the video content.

20. The method of claim 13, further comprising sending a session identifier in response to the request, wherein the session identifier is configured to be received in a second or subsequent request from the rendering device in relation to the received video content.

21. Apparatus comprising:
a memory that stores a plurality of instructions; and
a processor coupled to the memory and configured to execute the instructions to:
receive an identifier of a video content and model information of a rendering device, the video content having first dynamic range and color gamut;
obtain from a source a first transformation function information according to the identifier of the video content and the model information of the rendering device, the first transformation function information for converting the video content into a converted video content with a second dynamic range different from the first dynamic range, or a second color gamut different from the first color gamut, or both; and
send to the rendering device the first transformation function information.
